(19) United States
(12) Patent Application Publication
(10) Pub. No.: US 2023/0176882 A1
(43) Pub. Date: Jun. 8, 2023

(54) METHOD FOR SIMULATING A CONTROL UNIT ON A COMPUTER BASED ON THE AUTOSAR STANDARD, AND COMPUTER THEREFOR

(71) Applicant: dSPACE GmbH, Paderborn (DE)

(72) Inventor: Frank LUENSTROTH, Paderborn (DE)

(73) Assignee: dSPACE GmbH, Paderborn (DE)

(21) Appl. No.: 18/076,977

(22) Filed: Dec. 7, 2022

(30) Foreign Application Priority Data
Dec. 8, 2021 (DE) 10 2021 132 235.9

(51) Int. Cl. G06F 9/455; G06F 11/34

(52) U.S. Cl. CPC G06F 9/455; G06F 11/3495

(57) ABSTRACT

A method for simulating a control unit, based on the AUTOSAR standard, different tasks being processed in consecutive time steps, the execution time needed to carry out all tasks in a time step being assumed to be zero, and the method including: Measuring the execution time of a task, an upper threshold being defined for the execution time for the particular task with the aid of the AUTOSAR parameter upon the exceeding of which the call of the AUTOSAR function is provided; and/or measuring the activation time of a task, an upper threshold being defined for the activation time for the particular task with the aid of the AUTOSAR parameter; and/or changing an AUTOSAR parameter for at least one time step in such a way that it is greater than the measured actual activation time.

This nonprovisional application claims priority under 35 U.S.C. § 119(a) to German Patent Application No. 10 2021 132 235.9, which was filed in Germany on Dec. 8, 2021, and which is herein incorporated by reference.

### BACKGROUND OF THE INVENTION

### Field of the Invention

The present invention relates to a method for simulating a control unit on a computer, based on the AUTOSAR standard, and also to a computer therefor, different tasks being processed in consecutive time steps during the simulation of the control unit, the tasks each being in one of the four states of “ready,” “waiting,” “running,” or “suspended” according to the AUTOSAR standard, all tasks which are in the “ready” state at each time step or which still retain the ready” state in this time step being carried out consecutively, and the execution time needed to carry out all tests in a time step being assumed to be zero.

### Description of the Background Art

With respect to the AUTOSAR standard, the specification of this standard forms the basis in the present case, as described in the document “Specification of Operating System, Document Identification No. 034,” AUTOSAR Release 4.2.2. This document has been made freely accessible by AUTOSAR and is available, for example, on the Internet: www.autosar.org, and is incorporated herein by reference.

The zero time assumption exists for simulating a control unit as a virtual control unit (V-ECU). This means that, when simulating a control unit which operates according to the AUTOSAR standard, all tasks which are in the “ready” state or which receive the “ready” state are carried out consecutively at a time step. The execution time needed to calculate all tasks is assumed to be zero. This may be viewed in such a way that the V-ECU is theoretically calculated on a CPU having an infinite speed. This results in a deterministic simulation behavior, but also has the disadvantage that certain temporal effects of a real ECU, i.e. of a real control unit, may not be simulated. In a real ECU, the tasks are monitored by the AUTOSAR operating system with the aid of a timing protection function. A distinction is made between the functions “execution time protection,” “locking time protection,” and “interarrival time protection.”

If a time violation occurs, the AUTOSAR standard requests the call of the function “ProtectionHook( )” with the error code “E_OS_PROTECTION_TIME” or with the error code “E_OS_PROTECTION_ARRIVAL.” The function “ProtectionHook( )” is called by the AUTOSAR operating system in the case of a protection violation relating to the memory or the timing, determines which of the actions relating to the possible actions of “End task,” “Restart,” and “Shut down,” of the ECU are to be carried out, and is provided by the ECU integrator, the operating system responding to the decision by checking the return value.

The function “ProtectionHook( )” and the behavior when calling this function, i.e. a restart or a shutdown of the ECU, is thus part of the control unit software which a user of this control unit wishes to test. However, no time violations occur due to the zero time assumption during a simulation of a control unit of this type, and up to now it has therefore not been possible to test this software part.

### SUMMARY OF THE INVENTION

It is therefore an object of the present invention to provide a possibility for carrying out a test of the function “ProtectionHook( )” and the behavior of the control unit when calling this function during the simulation of a control unit which operates according to the AUTOSAR standard.

According to an exemplary embodiment of the invention, a method is thus provided for simulating a control unit on a computer, based on the AUTOSAR standard, different tasks being processed in consecutive time steps during the simulation of the control unit; the tasks each being in one of the four states of “ready,” “waiting,” “running,” or “suspended” according to the AUTOSAR standard; at each time step, all tasks which are in the “ready” state or which still retain the “ready” state in this time step being carried out consecutively; the execution time needed to carry out all tasks in a time step being assumed to be zero; and the method includes the following method steps: measuring the actual execution time of a task on the computer with the aid of a hardware timer, an upper threshold being defined for the execution time for the particular task with the aid of the AUTOSAR parameter “OsTaskExecutionBuget,” upon the exceeding of which the call of the AUTOSAR function “ProtectionHook( )” is provided, and/or measuring the actual activation time of a task on the computer with the aid of a hardware timer, an upper threshold being defined for the activation time for the particular task with the aid of the AUTOSAR parameter “OsTaskTimeFrame,” upon the exceeding of which the call of the AUTOSAR function “ProtectionHook( )” is provided; and if the actual execution time of the task was measured, changing the AUTOSAR parameter “OsTaskExecutionBuget” for at least one time step in such a way that it is less than the measured actual execution time, and/or if the actual activation time of the task was measured, changing the AUTOSAR parameter “OsTaskTimeFrame” for at least one time step in such a way that it is greater than the measured actual activation time, so that the AUTOSAR function “ProtectionHook( )” is called during the simulation.

The present case is therefore a control unit, which is operated according to the AUTOSAR standard, so that the simulation of the control unit on the computer naturally also takes place on the basis of the AUTOSAR standard.

In industrial computer science and in electronics, a control module used to implement time-related functions is referred to as a timer. The term, “Hardware time,” used in the present case refers to the fact that it is a hardware component in the present case.

Within the scope of the invention, measuring the execution and activation times of different tasks using a real timer, the hardware time, is thus made possible between the virtual time steps within the operating system. These real measured times may be configured in such a way that the effects of the “timing protection” provided in the AUTOSAR standard may be simulated, despite the zero time assumption. At this point, it should again be made clear that the real measured times have nothing to do with which time would be needed to calculate a task on the real control unit. This time for calculating a task on the real control unit is not used for the present invention.

Within the scope of the AUTOSAR standard, the maximum execution time on the control unit which a task is allowed to have is defined with the aid of the threshold value “OsTaskExecutionBuget.”. If it is exceeded, a call of the function “ProtectionHook( )” takes place. With respect to the threshold value “OsTaskTimeFrame,” the AUTOSAR standard provides that the function “ProtectionHook( )” is called if an attempt is made to start one of the two transitions “release” and “activate” for a second task before the activation time for a first task has elapsed. “OsTaskTimeFrame” thus regulates the minimum interval between two consecutive tasks.

In principle, the method according to the invention may be used on different platforms. According to one preferred specific embodiment of the invention, the computer is operated under the Windows or Linux operating system, and the hardware timer is a Windows hardware timer or a Linux hardware timer.

The AUTOSAR parameter “OsTaskExecutionBuget” preferably has the value “infinite” at the beginning of the simulation, and/or the AUTOSAR parameter “OsTaskTimeFrame” has the value “zero.” In this way, a time violation is reliably prevented during a first run of the simulation, so that the simulation completes the actual execution time of a task of interest on the computer and may be measured with the aid of the hardware timer. The measured time may then be used in a later run of the simulation to induce the call of the AUTOSAR function “ProtectionHook( )” According to one preferred embodiment of the invention, it is thus provided that a complete simulation of the control unit is carried out first, and the AUTOSAR parameter “OsTaskExecutionBudget” and/or the AUTOSAR parameter “OsTaskTimeFrame” is/are changed for a time step in a subsequent simulation.

The call of the AUTOSAR function “ProtectionHook( )” can effectuate a restart of the simulated control unit during the simulation. It is also exceptionally particularly preferred that the simulated control unit includes a plurality of cores, and the call of the AUTOSAR function “ProtectionHook( )” effectuates a restart of a core of the simulated control unit during the simulation. The restart of a core of the simulated control unit represents a behavior of the control unit, which is of special interest to the user of a real control unit of this type. Additionally or alternatively, it may be provided according to one preferred refinement of the invention that the call of the AUTOSAR function “ProtectionHook( )” effectuates a restart of an operating system application of the simulated control unit during the simulation.

According to the invention, a computer is also provided to simulate a control unit, based on the AUTOSAR standard, the computer being configured in such a way that different tasks are processed in consecutive time steps during the simulation of the control unit; the tasks are each in one of the four states of “ready,” “waiting,” “running,” or “suspended” according to the AUTOSAR standard; at each time step, all tasks which are in the “ready” state or which still retain the “ready” state in this time step are carried out consecutively; the execution time needed to carry out all tasks in a time step is assumed to be zero; the computer including a hardware timer, which is configured to measure the actual execution time and/or the actual activation time of a task on the computer in a time step, an upper threshold being defined for the execution time for the particular task with the aid of the AUTOSAR parameter “OsTaskExecutionBuget,” upon the exceeding of which the call of the AUTOSAR function “ProtectionHook( )” is provided, and/or an upper threshold being defined for the activation time for the particular task with the aid of the AUTOSAR parameter “OsTaskTimeFrame,” upon the exceeding of which the call of the AUTOSAR function “ProtectionHook( )” is provided; and if the actual execution time of the task was measured, the computer is configured to change the AUTOSAR parameter “OsTaskExecutionBuget” for at least one time step in such a way that it is less than the measured actual execution time, and/or if the actual activation time of the task was measured, it is configured to change the AUTOSAR parameter “OsTaskTimeFrame” for at least one time step in such a way that it is greater than the measured actual activation time, so that the AUTOSAR function “ProtectionHook( )” is called during the simulation.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows the possible states of a task according to the AUTOSAR standard as well as the defined transitions between these states; and

FIG. 2 schematically shows a method according to one preferred exemplary embodiment of the invention.

### DETAILED DESCRIPTION

According to an example, a control unit which operates according to the AUTOSAR standard is simulated on a computer, which is operated under the Windows operating system and is provided with a Windows hardware timer.

During the simulation of a control unit operating according to the AUTOSAR standard, different tasks are processed in consecutive time steps. The tasks are each in one of the four states of “ready,” “waiting,” “running,” or “suspended” according to the AUTOSAR standard. In each time step, all tasks which are in the “ready” state or which still retain the “ready” state in this time step are carried out consecutively. The execution time needed to carry out all tasks in a time step is assumed to be zero, as already mentioned above.

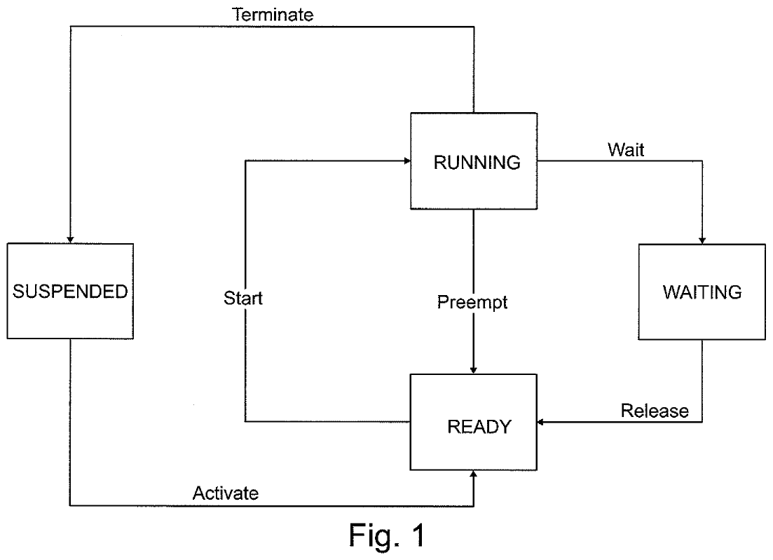

According to the AUTOSAR operating system, each task thus has a defined state, and defined transitions between these transitions are provided. If a task changes state, the times for which threshold values are defined with the aid of the parameters “OsTaskExecutionBuget” and “OsTaskTimeFrame” are measured according to the AUTOSAR standard. This is apparent schematically from FIG. 1. If these threshold values are exceeded or fail to be reached, a “timing protection” situation defined in the AUTOSAR standard may occur, and thus a call of the function “ProtectionHook( ).”

In terms of content, FIG. 1 corresponds in simplified form to FIG. 7.12 of the aforementioned AUTOSAR document. The four states defined in the AUTOSAR document of “ready,” “waiting,” “running,” and “suspended” are shown in FIG. 1 as are the defined transitions between these states, which are designated according to the AUTOSAR standard as “start,” “activate,” “wait,” “release,” “preempt,” and “terminate.” The following time measurements also occur in a real control unit:

The time measurement relating to the threshold value “OsTaskExecutionBudget” is started during the transition from the “ready” state to the “running” state (“start”). The time measurement relating to the threshold value “OsTaskExecutionBudget” is stopped during the transition from the “running” state to the “ready” state (“preempt”).

The time measurement relating to the threshold value “OsTaskExecutionBudget” is reset during the transition from the “running” state to the “suspended” state (“terminate”). The time measurement relating to the threshold value “OsTaskExecutionBudget” is likewise reset during the transition from the “running” state to the “waiting” state (“terminate”).

The time measurement relating to the threshold value “OsTaskTimeFrame” is started during the transition from the “waiting” state to the “ready” state (“release”). The time measurement relating to the threshold value “OsTaskTimeFrame” is likewise started during the transition from the “suspended” state to the “ready” state (“activate”). As already described above, “OsTaskTimeFrame” regulates the minimum time interval between two consecutive tasks. With regard to this threshold value, the time interval between two consecutive tasks is therefore measured.

The threshold value OsTaskExecutionBudget” initially can have the value “infinite,” and the “OsTaskTimeFrame” has the value “zero.” However, the two threshold values may be manipulated from the outside during the simulation. Since it is not possible to measure during the simulation itself whether these threshold values are exceeded or fail to be reached, one proceeds as follows:

The actual execution time of a task on the computer used for the present simulation is measured with the aid of a hardware timer. The time measurement is therefore not based on a virtual time resulting from the simulation, but on a real time measured with the aid of the Windows hardware timer. If, as is apparent in FIG. 1, one of the two times relating to the threshold values “OsTaskExecutionBuget” and “OsTaskTimeFrame” is reset, the measured times relating hereto are stored by the AUTOSAR operating system. These times relating to “OsTaskExecutionBuget” and “OsTaskTimeFrame” are then known for each task after a first simulation.

If the actual execution time of a task was measured, the AUTOSAR parameter “OsTaskExecutionBuget” is changed for a later time step, i.e. manipulated, in such a way that it is less than the measured actual execution time. This results in an induced call of the function “ProtectionHook( )” The call of this function may also be likewise induced by changing the AUTOSAR parameter “OsTaskTimeFrame” for a later time step of the simulation in such a way that it is greater than the measured actual activation time.

During the call of the AUTOSAR function “ProtectionHook( )” a restart of the simulated control unit may now occur during the simulation, so that this situation may also be tested. If the simulated control unit includes a plurality of cores, the call of the AUTOSAR function “ProtectionHook( )” during the simulation may also effectuate a restart of a core of the simulated control unit, so that this situation may also be tested. The call of the AUTOSAR function “ProtectionHook( )” during the simulation may also effectuate a restart of an operating system application, which also expands the testing possibilities during the simulation.

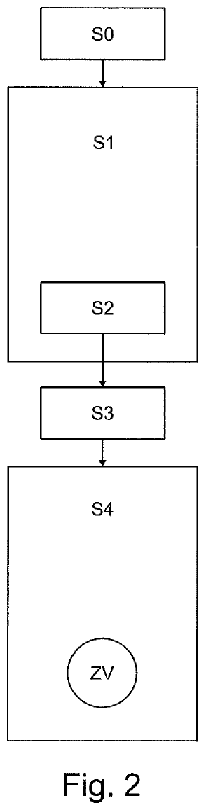

In summary, the method according to the present preferred exemplary embodiment may be described as follows with reference to the method sequence illustrated schematically in FIG. 2:

S0: Before the first run of the simulation, the threshold value for “OsTaskExecutionBuget” is set to the value “infinite,” and the threshold value for “OsTaskTimeFrame” is set to the value “zero.”

S1: The first run of the simulation takes place. No time violation may occur due to the values set for “OsTaskExecutionBuget: and “OsTaskTimeFrame.”

S2: Within the scope of the first run of the simulation, the actual particular execution times of all tasks on the computer and the actual particular activation times of all tasks on the computer are measured with the aid of a hardware timer. Deviations from the measurement of these times for all tasks may naturally occur in that these times are measured only for fewer tasks or only for one task.

S3: At the end of the first run of the simulation, the threshold values for “OsTaskExecutionBuget” and “OsTaskTimeFrame” are changed for at least one task in such a way that the threshold value “OsTaskExecutionBuget” is less than the measured actual execution time, and/or the threshold value “OsTaskTimeFrame” is greater than the measured actual activation time.

S4: A new run of the simulation then takes place with these new threshold values, within the scope of which a provoked call of the function “ProtectionHook( )” occurs, due to a provided time violation ZV.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for simulating a control unit based on the AUTOSAR standard on a computer, wherein different tasks are processed in consecutive time steps during the simulation of the control unit, the tasks are each in one of the four states of “ready,” “waiting,” “running,” or “suspended” according to the AUTOSAR standard, at each time step, all tasks which are in the “ready” state or which still retain the “ready” state in this time step are carried out consecutively, the execution time needed to carry out all tasks in a time step is assumed to be zero, the method comprising:
measuring the actual execution time of a task on the computer with the aid of a hardware timer, an upper threshold being defined for the execution time for the particular task with the aid of the AUTOSAR parameter “OsTaskExecutionBuget,” upon the exceeding of which the call of the AUTOSAR function “ProtectionHook( )” is provided, and/or measuring the actual activation time of a task on the computer with the aid of a hardware timer, an upper threshold being defined for the activation time for the particular task with the aid of the AUTOSAR parameter “OsTaskTimeFrame,” upon the exceeding of which the call of the AUTOSAR function “ProtectionHook( )” is provided; and
changing, if the actual execution time of the task was measured, the AUTOSAR parameter “OsTaskExecutionBuget” for at least one time step in such a way that it is less than the measured actual execution time, and/or if the actual activation time of the task was measured, changing the AUTOSAR parameter “OsTaskTimeFrame” for at least one time step in such a way that it is greater than the measured actual activation time, so that a call of the AUTOSAR function “ProtectionHook( )” occurs during the simulation.

2. The method according to claim 1, wherein the computer is operated under the Windows or Linux operating system, and the hardware timer is a Windows hardware timer or a Linux hardware timer.

3. The method according to claim 1, wherein the AUTOSAR parameter “OsTaskExecutionBuget” has the value “infinite” at the beginning of the simulation, and/or the AUTOSAR parameter “OsTaskTimeFrame” has the value “zero” at the beginning of the simulation.

4. The method according to claim 3, wherein a complete simulation of a function of the simulated control unit is carried out first, and the AUTOSAR parameter “OsTaskExecutionBudget” and/or the AUTOSAR parameter “OsTaskTimeFrame” is/are changed for a time step in a subsequent simulation.

5. The method according to claim 1, wherein the call of the AUTOSAR function “ProtectionHook( )” effectuates a restart of the simulated control unit during the simulation.

6. The method according to claim 1, wherein the simulated control unit includes a plurality of cores, and the call of the AUTOSAR function “ProtectionHook( )” effectuates a restart of a core of the simulated control unit during the simulation.

7. The method according to claim 1, wherein the call of the AUTOSAR function “ProtectionHook( )” effectuates a restart of an operating system application of the simulated control unit during the simulation.

8. A computer for simulating a control unit, based on the AUTOSAR standard, the computer being configured such that:
different tasks are processed in consecutive time steps during the simulation of the control unit;
the tasks are each in one of the four states of “ready,” “waiting,” “running,” or “suspended” according to the AUTOSAR standard;
at each time step, all tasks which are in the “ready” state or which still retain the “ready” state in this time step are carried out consecutively;
the execution time needed to carry out all tasks in a time step is assumed to be zero, wherein the computer includes a hardware timer, which is configured to measure the actual execution time and/or the actual activation time of a task on the computer in a time step, an upper threshold being defined for the execution time for the particular task with the aid of the AUTOSAR parameter “OsTaskExecutionBuget,” upon the exceeding of which the call of the AUTOSAR function “ProtectionHook( )” is provided, and/or an upper threshold being defined for the activation time for the particular task with the aid of the AUTOSAR parameter “OsTaskTimeFrame,” upon the exceeding of which the call of the AUTOSAR function “ProtectionHook( )” is provided; and
if the actual execution time of the task was measured, the computer is configured to change the AUTOSAR parameter “OsTaskExecutionBuget” for at least one time step in such a way that it is less than the measured actual execution time, and/or if the actual activation time of the task was measured, it is configured to change the AUTOSAR parameter “OsTaskTimeFrame” for at least one time step in such a way that it is greater than the measured actual activation time, so that the AUTOSAR function “ProtectionHook( )” is called during the simulation.
